(19) United States
(12) Patent Application Publication
(10) Pub. No.: US 2005/0064234 A1
(43) Pub. Date: Mar. 24, 2005

(54) Emissive polymer layer

(76) Inventors: Franky So, San Jose, CA (US); Vi-En Choong, San Jose, CA (US); Aditee A. Patwardhan, Sunnyvale, CA (US)

Correspondence Address: Siemens Corporation;Intellectual Property Department, 170 Wood Avenue South, Iselin, NJ, 08830, US

(21) Appl. No.: 10/666,283

(22) Filed: Sep. 18, 2003

(51) Int. Cl. H05B 33/14; C09K 11/06

(52) U.S. Cl. 428/690; 428/917; 313/504; 313/506; 257/40; 252/301.35

(57) ABSTRACT

The emissive layer of an organic light emitting diode (“OLED”) device is comprised of multiple polymer chains. In an embodiment of a polymer chain according to the present invention, a portion of the polymer chain is formed by coupling together multiple monomers of two different types. In addition, one end group is coupled to one end of the portion of the polymer chain and another end group is coupled to the opposite end of the portion of the polymer chain. In this embodiment of the polymer chain, the end groups are of the same type and only the end groups emit visible light.

### BACKGROUND OF THE INVENTION

An organic light emitting diode (“OLED”) display is typically comprised of: (1) a transparent anode on a substrate; (2) a hole transporting layer (“HTL”); (3) an electron transporting and light emitting layer (“emissive layer”); and (4) a cathode. When a forward bias is applied, holes are injected from the anode into the HTL, and the electrons are injected from the cathode into the emissive layer. Both carriers are then transported towards the opposite electrode and allowed to recombine with each other, the location of which is called the recombination zone; the recombinations in the emissive layer produce visible light.

In this OLED display configuration, the emissive layer performs the electron transporting, the electron injecting, the hole transporting, the hole injecting, and the emitting functions. Typically, the emissive layer is comprised of multiple polymer chains and each of the polymer chains is comprised of multiple monomers of the same type. Having polymer chains comprised of only one type of monomer compromises the effectiveness of the resulting emissive layer. For example, an emissive layer comprised of only one type of monomer typically has high electron mobility but relatively poor hole mobility or vice versa; the emissive layer typically does not have both high electron mobility and high hole mobility. If the emissive layer has a high hole mobility, then the recombination zone occurs close to the cathode thus decreasing efficiency. If the emissive layer has a high electron mobility, then the recombination zone occurs close to the HTL thus decreasing display lifetime due to, for example, delamination at the HTL-anode interface.

If the polymer chains of the emissive layer is comprised of only one monomer, then the chain's properties such as electron mobility, electron injection, hole mobility, hole injection, and emission cannot be individually optimized or individually tailored for a specific application. For example, if an emissive layer material has the desired electron mobility and hole mobility but emits yellow light, then this material cannot be used as the emissive layer within an OLED that is intended to emit green light.

If the polymer chains of the emissive layer is comprised of only one monomer type, then that monomer has to perform multiple functions and therefore the number of monomer types that can be used in the polymer chain is reduced to those monomer types that can perform the multiple functions. Because the selected monomer type has to perform multiple functions, the pool of monomer types from which that monomer can be chosen is reduced.

Further, degradation of the emissive layer material results in the degradation of all of its properties; for example, degradation of the material results in degradation of its emissive properties (e.g., the emission intensity), the hole transporting properties, and the electron transporting properties.

Therefore, in order to improve OLED device efficiency, lifetime, and fabrication flexibility, different components should be responsible for different functions so that, for example, the different components are individually tailorable.

### SUMMARY

An emissive polymer layer includes at least one polymer chain. An embodiment of one of these polymer chains includes at least one first monomer and at least one second monomer and each of the at least one first monomer and each of the at least one second monomer are coupled together to form a portion of the polymer chain. One of two end groups is coupled to one end of the portion of the polymer chain and another end group is coupled to the opposite end of the portion of the polymer chain. In this embodiment of the polymer chain, only the two end groups emit visible light.

### BRIEF DESCRIPTION OF THE DRAWINGS

FIG. 1 shows an embodiment of a polymer chain according to the present invention.

FIGS. 2a-c show energy band diagrams for different configurations of the end group C.

FIG. 3 shows a cross-sectional view of an embodiment of an OLED device according to the present invention.

FIG. 4 shows a cross-sectional view of another embodiment of an OLED device according to the present invention.

### DETAILED DESCRIPTION

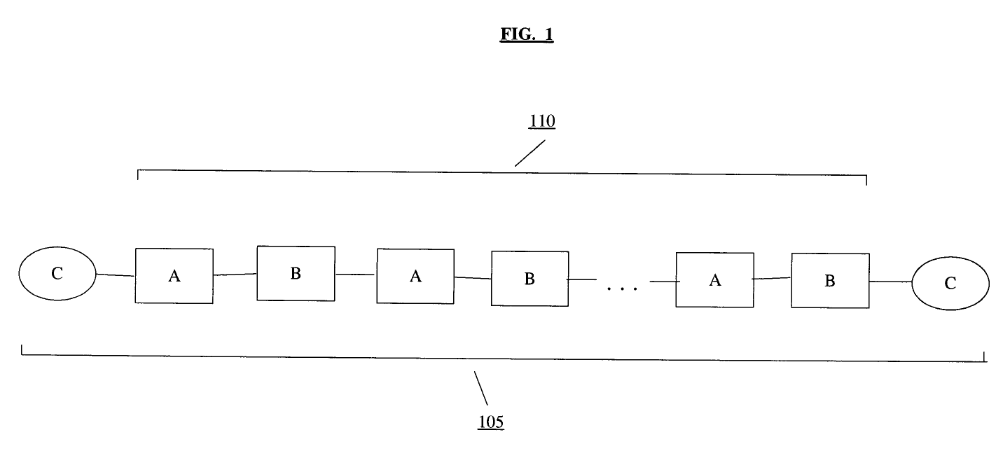

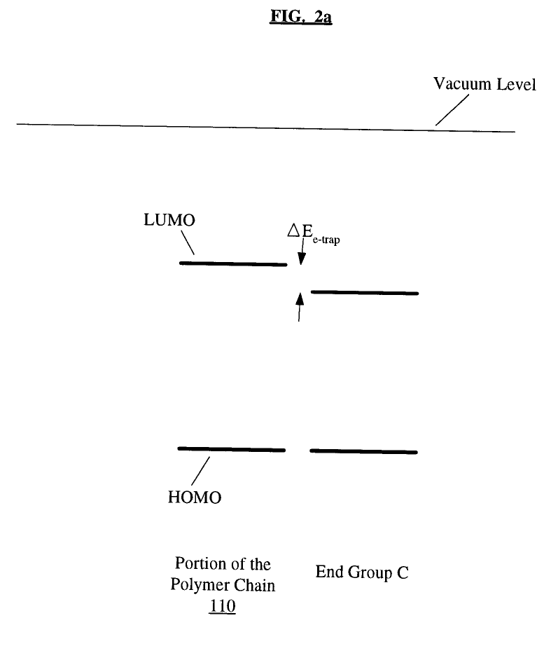

The emissive layer of an OLED device is comprised of multiple polymer chains. In an embodiment of a polymer chain according to the present invention, a portion of the polymer chain is formed by coupling together multiple monomers of two different types. In addition, one end group is coupled to one end of the portion of the polymer chain and another end group is coupled to the opposite end of the portion of the polymer chain. In this embodiment of the polymer chain, the end groups are of the same type and only the end groups emit visible light. FIG. 1 shows the embodiment of the polymer chain 105 according to the present invention. In FIG. 1, the polymer chain 105 includes the monomers A, the monomers B, and the end groups C and these three components are coupled together to form the main chain. Multiple monomers of two different types (i.e., monomers A and monomers B) are coupled (e.g., chemically coupled) together to form a portion of the polymer chain 110. The portion of the polymer chain 110 transport electrons and holes from one end of the polymer chain to the opposite end of the polymer chain. One end group C is coupled to one end of the portion of the polymer chain 110 and another end group C is coupled to the opposite end of the portion of the polymer chain 110. Visible light is emitted only at the end groups C. The emission of light occurs due to recombination, fluorescence, or phosphorescence.

In this embodiment, the monomers A are responsible for electron injection and transport, i.e., they have high electron mobility and provide a low energy barrier for electron injection from an adjacent layer such as the cathode. The energy barrier is considered low if, for example, there is a gap of 0.3 eV or less. Because monomers A are primarily responsible for electron injection and transport, the monomers A can be selected primarily for its electron injection and transport properties while generally ignoring its other properties such as its emission properties. By being able to select a monomer primarily for one property increases the pool of monomer types from which that monomer can be chosen. For example, the monomers A can be taken from a known electron transporting material.

In this embodiment, the monomers B are responsible for hole injection and transport, i.e., they have high hole mobility and provide a low energy barrier for hole injection from, for example, a hole transporting layer or an anode. Because monomers B are primarily responsible for hole injection and transport, the monomers B can be selected primarily for its hole injection and transport properties while generally being able to ignore its other properties such as its emission properties. By being able to select a monomer primarily for one property increases the pool of monomer types from which that monomer can be chosen. For example, the monomers B can be taken from a known hole transporting material.

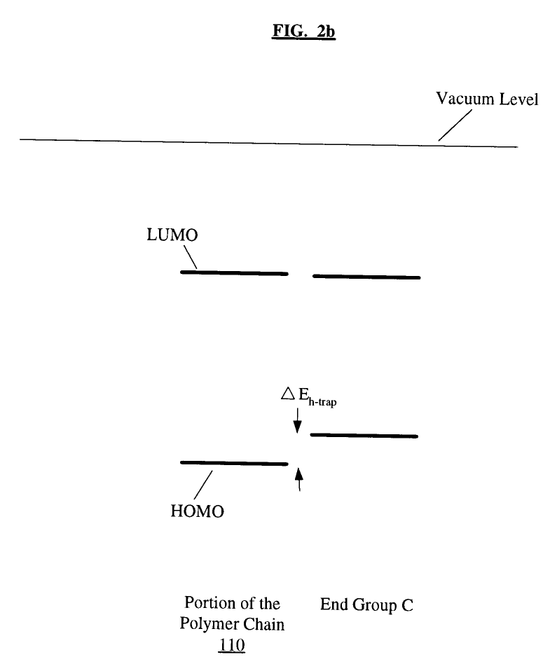

In this embodiment, only the end groups C emit visible light. The end groups C are fluorescent centers, phosphorescent centers, or charge traps. If the end groups C are traps, then the end groups C capture electrons and/or holes. Once an electron or hole is trapped at an end group, then the probability that another carrier of the opposite charge will also be trapped increases thus increasing the efficiency of the device. FIG. 2a shows an energy band diagram for a first configuration of the end group C in which it traps electrons. In order to trap electrons, the end group C has a lower LUMO (“lowest unoccupied molecular orbital”) level than the portion of the polymer chain 110 so there is an energy barrier to trap electrons (this is specified by “ΔEₑ₋ₜᵣₐₚ”). The energy barrier to trap electrons is, for example, at least 0.1 eV (e.g., a difference between a LUMO (“lowest unoccupied molecular orbital”) level of the end group C and a LUMO level of the portion of the polymer chain 110 is at least 0.1 eV). In this first configuration, the end group C does not trap holes (e.g., the difference in HOMO (“highest occupied molecular orbital”) levels between the portion of the polymer chain 110 and the end group C is insignificant; for example, this difference may be less than 0.1 eV).

FIG. 2b shows an energy band diagram for a second configuration of the end group C in which it traps holes. In order to trap holes, the end group C has a higher HOMO level than the portion of the polymer chain 110 so there is an energy barrier to trap holes (this is specified by “ΔEₕ₋ₜᵣₐₚ”). The energy barrier to trap holes is, for example, at least 0.1 eV (e.g., a difference between a HOMO level of the end group C and a HOMO level of the portion of the polymer chain 110 is at least 0.1 eV). In this second configuration, the end group C does not trap electrons (e.g., the difference in LUMO levels between the end group C and the portion of the polymer chain 110 is insignificant and electrons can easily overcome this barrier).

FIG. 2c shows an energy band diagram for a third configuration of the end group C in which it traps both holes and electrons. In order to trap holes, the end group C has a higher HOMO level than the portion of the polymer chain 110; and in order to trap electrons, the end group C has a lower LUMO level than the portion of the polymer chain 110. The difference between the LUMO level of the end group C and the LUMO level of portion of the polymer chain 110 is, for example, at least 0.1 eV. The difference between the HOMO level of the end group C and the HOMO level of the portion of the polymer chain 110 is, for example, at least 0.1 eV.

By having different components (e.g., the monomers A, the monomers B, and the end groups C) responsible for different functions, the efficiency and reliability of the OLED device can be improved. The efficiency of the device is improved since each of the components can be individually optimized for a different function. In addition, since the emissive layer can have good hole injection and transport properties and also good electron injection and transport properties, the number of electrons and holes in the emissive layer can be almost equal thus improving the device efficiency. The reliability of the device is improved since a material with multiple components optimized for different functions degrade at a slower rate than a material with one component performing multiple functions. In addition, the reliability of the device is improved since degradation of one component does not result in degradation of all of the components. For example, the component responsible for hole transporting may degrade resulting in low hole mobility, but this may not translate to degradation of the component responsible for emission and thus the luminance may not be affected.

The portion of the polymer chain 110 is comprised of at least one monomer A and at least one monomer B. More specifically, the number of monomers of type A in the chain can range from one monomer to thousands of monomers. Similarly, the number of monomers of type B in the chain can range from one monomer to thousands of monomers.

The emissive layer is comprised of polymer chains and each of the chains can have the same arrangement of the monomers A and the monomers B or alternatively some or all of the chains can have a different arrangement of the monomers A and the monomers B. Within a polymer chain, the monomers A and the monomers B can be coupled together in any arrangement. A polymerization reaction couples together the monomers. The arrangement of the monomers within the chain depends on the reactivity of monomer A with monomer B, the reactivity of monomer A with monomer A, and the reactivity of monomer B with monomer B. In a first configuration of the embodiment of the polymer chain 105 as shown in FIG. 1, each of the monomers A is coupled to a corresponding one of the monomers B to form an alternating pattern of monomers A and monomers B. Alternatively, in a second configuration of the embodiment of the polymer chain 105 (not shown), a monomer A is coupled to another monomer A which is coupled to a monomer B and this is coupled to another monomer B. In this second configuration, the monomers A and the monomers B are coupled together to form the following repeating pattern: A-A-B-B. In a third configuration of the embodiment of the polymer chain 105 (not shown), the monomers A and the monomers B are randomly coupled together as shown by, for example, the following arrangement: A-A-B-A-B-B-A-A-A-B-B-B-A.

Since the end groups C are coupled to the ends of the portion of the polymer chain, the configuration of the polymer chain 105 provides flexibility since the color emitted by the polymer chain 105 can be easily changed by removing the end groups of the original polymer chain and coupling a different type of end groups to the ends of the portion of the polymer chain. The color emitted by the original polymer chain can be changed by replacing the end groups of the original polymer chain with a different type of end group while still maintaining the electron injection and transporting properties and the hole injection and transporting properties of the original polymer chain since the monomers A and the monomers B of the original polymer chain are not replaced. Since the end groups C can be chosen purely for its emission properties without consideration to its mobility and injection properties, the emission properties of the polymer chain can be individually optimized and this improves the efficiency of the OLED device. The color of light emitted by the emissive layer depends on the type of end group C used in the polymer chain. By using multiple emissive layers where the emissive layers use different end groups C, broad-spectrum colors such as white can be easily produced by a multilayer OLED device.

The end groups C can be chosen to improve the OLED device reliability. The reliability can be improved by, for example, choosing an end group that has a high molecular weight so that the glass transition temperature of the polymer chain is increased thus reducing the likelihood of packing and crystallization.

The ratio of the monomers A to the monomers B depends on their respective properties. The ratio of these monomers can be adjusted so that the hole transport and injection rate is balanced with the electron transport and injection rate (i.e., the ratio is balanced so that there is an approximately equal number of holes and electrons in the emissive layer resulting in improved device efficiency). For example, if the monomers A have a rate of electron mobility that is higher than the rate of hole mobility of the monomers B, then there can be a greater amount of the monomers B in the polymer chain to compensate for its slower rate.

The concentration of the end groups C in the polymer chain 105 is much less than the concentration of the monomers A or the concentration of the monomers B. Preferably, the concentration of the end groups C in the polymer chain 105 is less than 0.5% of the concentration of the monomers A or the concentration of the monomers B. More preferably, the concentration of the end groups C in the polymer chain 105 is less than 0.5% of the lesser of the concentration of the monomers A or the concentration of monomers B.

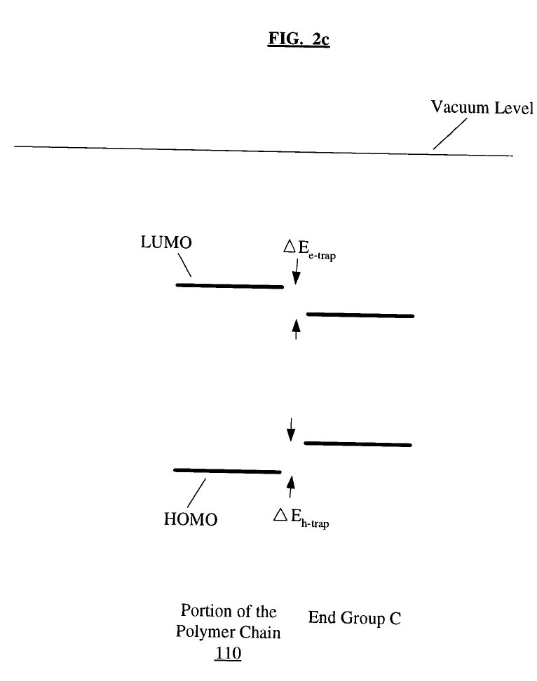

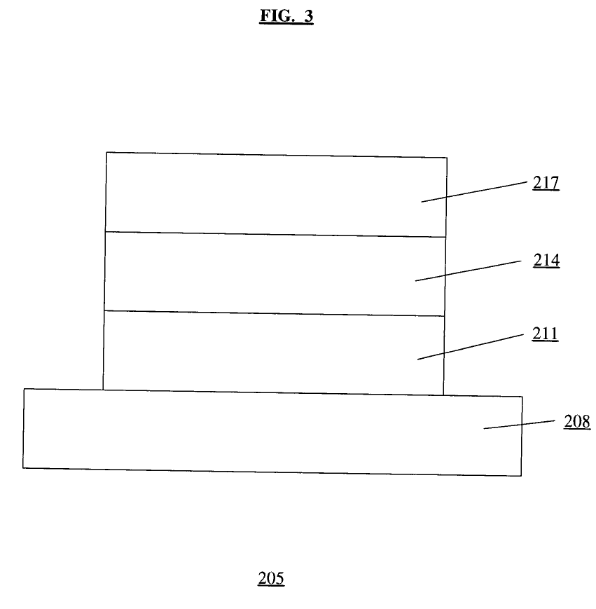

An emissive layer of an OLED device can be comprised of multiple polymer chains according to the embodiment described earlier. FIG. 3 shows a cross-sectional view of an embodiment of an OLED device 205 according to the present invention. The OLED device 205 can be, for example, an OLED display or an OLED light source used for general purpose lighting. In FIG. 3, an anode 211 is on a substrate 208. As used within the specification and the claims, the term “on” includes when there is direct physical contact between the two parts (e.g., layers) and when there is indirect contact between the two parts because they are separated by one or more intervening parts. An emissive layer 214 is on the anode 211. A cathode 217 is on the emissive layer 214. Each of these layers is described in greater detail below.

Substrate 208:

The substrate 208 can be any material, which can support the layers, and is transparent or semi-transparent to the wavelength of light generated in the device. The substrate 208 can be transparent or opaque (e.g., the opaque substrate is used in top-emitting devices). By modifying or filtering the wavelength of light which can pass through the substrate, the color of light emitted by the device can be changed. Preferable substrate materials include glass, quartz, silicon, and plastic, preferably, thin, flexible glass. The preferred thickness of the substrate 208 depends on the material used and on the application of the device. The substrate 208 can be in the form of a sheet or continuous film. The continuous film is used, for example, for roll-to-roll manufacturing processes which are particularly suited for plastic, metal, and metallized plastic foils.

First Electrode 211:

In one configuration of this embodiment, the first electrode 211 functions as an anode (the anode is a conductive layer which serves as a hole-injecting layer and which comprises a material with work function greater than about 4.5 eV). Typical anode materials include metals (such as platinum, gold, palladium, indium, and the like); metal oxides (such as lead oxide, tin oxide, ITO, and the like); graphite; doped inorganic semiconductors (such as silicon, germanium, gallium arsenide, and the like); and doped conducting polymers (such as polyaniline, polypyrrole, polythiophene, and the like).

In an alternative configuration, the first electrode 211 functions as a cathode (the cathode is a conductive layer which serves as an electron-injecting layer and which comprises a material with a low work function). The cathode, rather than the anode, is deposited on the substrate 208 in the case of, for example, a top-emitting OLED. Typical cathode materials are listed below in the section for the “second electrode 217”.

The first electrode 211 can be transparent, semi-transparent, or opaque to the wavelength of light generated within the device. Preferably, the thickness of the first electrode 211 is from about 10 nm to about 1000 nm, and more preferably from about 50 nm to about 200 nm.

The first electrode 211 can typically be fabricated using any of the techniques known in the art for deposition of thin films, including, for example, vacuum evaporation, sputtering, electron beam deposition, or chemical vapor deposition, using for example, pure metals or alloys, or other film precursors.

Emissive Layer 214:

The emissive layer 214 is comprised of multiple polymer chains. Each of the polymer chains includes a portion of the polymer chain comprised of monomers A and monomers B, and an end group C coupled to one end of the portion of the polymer chain and another end group C coupled to the opposite end of the portion of the polymer chain. In this embodiment, the monomers A are responsible for electron injection and transport, and the monomers B are responsible for hole injection and transport. In this embodiment, only the end groups C emit visible light. Greater details of the emissive layer 214 is provided above.

The thickness of the emissive layer 214 is from about 5 nm to about 500 nm, preferably, from about 20 nm to about 100 nm, and more preferably is about 75 nm.

The emissive layer 214 can be a continuous film that is nonselectively deposited by, for example, spin coating, or discontinuous regions that are selectively deposited by, for example, ink jet printing or screen printing.

Second Electrode 217:

In one configuration of this embodiment, the second electrode 217 functions as a cathode (the cathode is a conductive layer which serves as an electron-injecting layer and which comprises a material with a low work function). While the cathode can be comprised of many different materials, preferable materials include aluminum, silver, magnesium, calcium, barium, or combinations thereof. More preferably, the cathode is comprised of aluminum, aluminum alloys, or combinations of magnesium and silver.

In an alternative configuration, the second electrode 217 functions as an anode (the anode is a conductive layer which serves as a hole-injecting layer and which comprises a material with work function greater than about 4.5 eV). The anode, rather than the cathode, is deposited on the emissive layer 214 in the case of, for example, a top-emitting OLED. Typical anode materials are listed earlier in the section for the “first electrode 211”.

The thickness of the second electrode 217 is from about 10 nm to about 1000 nm, preferably from about 50 nm to about 500 nm, and more preferably, from about 100 nm to about 300 nm. There are many methods known to those of ordinary skill in the art by which to deposit the second electrode 217 and these methods include, for example, vacuum deposition and sputtering.

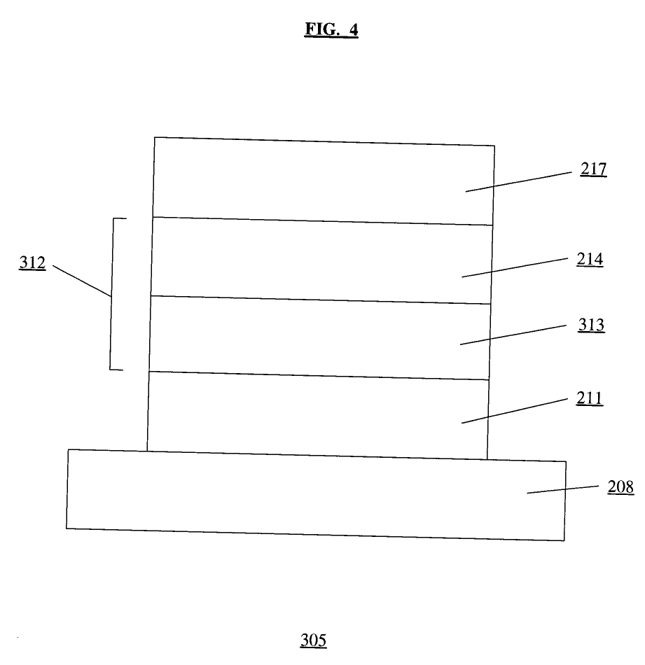

The OLED device may include an organic stack between the first electrode and the second electrode. The organic stack may include a hole transporting layer and an emissive layer. The hole transporting layer may be used to increase the efficiency of the OLED device. The hole transporting layer has high hole mobility and a low energy barrier for hole injection so that a greater number of holes are injected into the emissive layer 214 than if the hole transporting layer was not present. FIG. 4 shows a cross-sectional view of another embodiment of an OLED device 305 according to the present invention. In this embodiment of the OLED device 305, an organic stack 312 is between the first electrode 211 and the second electrode 217. The organic stack 312 includes a hole transporting layer 313 and the emissive layer 214. The hole transporting layer 313 is deposited on the first electrode 211. The emissive layer 214 is deposited on the hole transporting layer 313. The hole transporting layer 313 is used to increase the number of holes reaching the emissive layer 214 which can increase the efficiency of the OLED device 305.

With regards to the hole transporting layer, the hole transporting layer 313 may be formed from, for example, polyethylenedioxythiophene-polystyrenesulfonic acid (“PEDOT:PSS”) or polyaniline (“PANI”).

Preferably, the thickness of the hole transporting layer 313 is from about 5 to about 1000 nm, more preferably from about 20 to about 500 nm, and most preferably from about 50 to about 250 nm.

The hole transporting layer 313 is usually applied in the form of a solution. Many application methods are known to those of ordinary skill in the art. Examples include, but are not limited to, spin coating, dip coating, roll coating, spray-coating, blade coating, or thermal evaporation onto the first electrode 211. Printing techniques including, but not limited to, screen-printing, flexographic printing, and inkjet printing (drop-on-demand, continuous, or semi-continuous) may also be used to apply the hole transporting layer 313.

While the embodiment of the emissive layer is illustrated in which it is incorporated within an OLED device, this concept may be applied to other electronic devices that use an active electronic layer. For example, with a solar cell, the light responsive layer (i.e., the active electronic layer) can be comprised of polymer chains in which a portion of the polymer chain is comprised of monomers A and monomers B coupled together and these monomers are optimized to transport the detected current. The end groups C can be coupled to the ends of the portion of the polymer chain and can be used to detect the current. The OLED device described earlier can be used in applications such as, for example, computer displays, information displays in vehicles, television monitors, telephones, printers, and illuminated signs.

As any person of ordinary skill in the art of electronic device fabrication will recognize from the description, figures, and examples that modifications and changes can be made to the embodiments of the invention without departing from the scope of the invention defined by the following claims.

1. An emissive polymer layer that includes at least one polymer chain, a particular one of said at least one polymer chain, comprising:
at least one first monomer;
at least one second monomer, wherein each of said at least one first monomer and each of said at least one second monomer are coupled together to form a portion of said particular polymer chain; and
two end groups, wherein one of said two end groups is coupled to one end of said portion of said particular polymer chain and another one of said two end groups is coupled to an opposite end of said portion of said particular polymer chain, and
wherein only said two end groups emit visible light.

2. The emissive polymer layer of claim 1 wherein
said at least one first monomer and said at least one second monomer have different properties.

3. The emissive polymer layer of claim 1 wherein
said at least one first monomer provides high electron mobility; and
said at least one second monomer provides high hole mobility.

4. The emissive polymer layer of claim 1 wherein
said two end groups are fluorescent centers, phosphorescent centers, or charge traps.

5. The emissive polymer layer of claim 1 wherein
said two end groups trap any one of: (1) electrons, (2) holes, or (3) electrons and holes.

6. The emissive polymer layer of claim 1 wherein at least one of:
(1) a difference between a LUMO level of said one of said two end groups and a LUMO level of said portion of said particular polymer chain is at least 0.1 eV; and
(2) a difference between a HOMO level of said one of said two end groups and a HOMO level of said portion of said particular polymer chain is at least 0.1 eV.

7. The emissive polymer layer of claim 1 wherein
a concentration of said two end groups in said particular polymer chain is much less than a concentration of said at least one first monomer or a concentration of said at least one second monomer.

8. The emissive polymer layer of claim 1 wherein
a concentration of said two end groups in said particular polymer chain is less than 0.5% of a concentration of said at least one first monomer or a concentration of said at least one second monomer.

9. The emissive polymer layer of claim 1 wherein
a concentration of said two end groups in said particular polymer chain is less than 0.5% of the lesser of a concentration of said at least one first monomer or a concentration of said at least one second monomer.

10. The emissive polymer layer of claim 1 wherein each of said at least one first monomer and each of said at least one second monomer coupled together includes
each of said at least one first monomer coupled to a corresponding one of said at least one second monomer to form an alternating pattern of first monomers and second monomers.

11. A method to produce a particular one of at least one polymer chain of an emissive polymer layer, comprising:
coupling together each of at least one first monomer and each of at least one second monomer to form a portion of said particular polymer chain; and
coupling one of two end groups to one end of said portion of said particular polymer chain and another one of said two end groups to an opposite end of said portion of said particular polymer chain,
wherein only said two end groups emit visible light.

12. The method of claim 11 wherein
said at least one first monomer and said at least one second monomer have different properties.

13. The method of claim 11 wherein
said at least one first monomer provides high electron mobility; and
said at least one second monomer provides high hole mobility.

14. The method of claim 11 wherein
said two end groups are fluorescent centers, phosphorescent centers, or charge traps.

15. The method of claim 11 wherein
said two end groups trap any one of: (1) electrons, (2) holes, or (3) electrons and holes.

16. The method of claim 11 wherein at least one of:
(1) a difference between a LUMO level of said one of said two end groups and a LUMO level of said portion of said particular polymer chain is at least 0.1 eV; and
(2) a difference between a HOMO level of said one of said two end groups and a HOMO level of said portion of said particular polymer chain is at least 0.1 eV.

17. The method of claim 11 wherein
a concentration of said two end groups in said particular polymer chain is much less than a concentration of said at least one first monomer or a concentration of said at least one second monomer.

18. The method of claim 11 wherein
a concentration of said two end groups in said particular polymer chain is less than 0.5% of the lesser of a concentration of said at least one first monomer or a concentration of said at least one second monomer.

19. The method of claim 11 wherein coupling together each of said at least one first monomer and each of said at least one second monomer includes
coupling each of said at least one first monomer to a corresponding one of said at least one second monomer to form an alternating pattern of first monomers and second monomers.

20. A method to emit visible light through an emissive layer, said emissive layer includes at least one polymer chain, said method comprising:
transporting an electron or a hole from one end of a portion of a particular one of said at least one polymer chain to an opposite end of said portion of said particular polymer chain, said portion of said particular polymer chain includes at least one first monomer and at least one second monomer that are coupled to each other; and
emitting said visible light at one of two end groups, a first one of said two end groups coupled to said one end of said portion of said particular polymer chain and a second one of said two end groups coupled to said opposite end of said portion of said particular polymer chain.

21. The method of claim 20 further comprising
capturing at least one of: said electron and said hole at said first one of said two end groups.

22. The method of claim 20 wherein at least one of:
(1) a difference between a LUMO level of said first one of said two end groups and a LUMO level of said portion of said particular polymer chain is at least 0.1 eV; and
(2) a difference between a HOMO level of said first one of said two end groups and a HOMO level of said portion of said particular polymer chain is at least 0.1 eV.

23. The method of claim 20 wherein
emitting said visible light includes light emission occurring due to recombination, fluorescence, or phosphorescence.

24. The method of claim 20 wherein
said at least one first monomer and said at least one second monomer have different properties.

25. The method of claim 20 wherein
said at least one first monomer provides high electron mobility; and
said at least one second monomer provides high hole mobility.

26. An organic light emitting diode (“OLED”) device, comprising:
a substrate;
a first electrode on said substrate;
an organic stack on said first electrode;
a second electrode on said organic stack,
wherein said organic stack includes an emissive polymer layer, and
wherein said emissive polymer layer includes at least one polymer chain and a particular one of said at least one polymer chain includes
at least one first monomer;
at least one second monomer, wherein each of said at least one first monomer and each of said at least one second monomer are coupled together to form a portion of said particular polymer chain; and
two end groups, wherein one of said two end groups is coupled to one end of said portion of said particular polymer chain and another one of said two end groups is coupled to an opposite end of said portion of said particular polymer chain,
wherein only said plurality of end groups emit visible light.

27. The OLED device of claim 26 wherein said organic stack further includes a hole transporting layer, said hole transporting layer is between said emissive layer and said first electrode or said second electrode.

28. The OLED device of claim 26 wherein said organic stack further includes another emissive layer, wherein said other emissive layer has a different type of two end groups than said two end groups of said emissive layer.

29. The OLED device of claim 26 wherein said emissive polymer layer is deposited by spin coating, ink jet printing, or screen printing.

30. The OLED device of claim 26 wherein said OLED device is an OLED display, or an OLED light source used for general purpose lighting.
